(19) United States
(12) Patent Application Publication
(10) Pub. No.: US 2007/0104032 A1
(43) Pub. Date: May 10, 2007

(54) Watch housing

(76) Inventors: Merrick Falkenstein, Markham (CA); Kenneth Lui, Hong Kong (HK)

Correspondence Address: MEREK, BLACKMON & VOORHEES, LLC, 673 S. WASHINGTON ST., ALEXANDRIA, WV, 22314, US

(21) Appl. No.: 11/269,750

(22) Filed: Nov. 9, 2005

(51) Int. Cl. G04B 47/00

(52) U.S. Cl. 368/10

(57) ABSTRACT

A watch housing comprising a main body and a data storage device. The data storage device has an internal memory and an interface to connect the internal memory to a computer for the exchange of data between the computer and the internal memory. The data storage device is securable to the housing such that in a first position the interface is at least partially received within the main body and in a second position the interface is sufficiently clear of the main body to permit the interface to be connected to a computer.

### BACKGROUND OF THE INVENTION

With the use of computers and computer technology growing at seemingly expedential rates across all areas of business and residential life in general, a significant effort has been directed to the development of devices used to store data and that permit transport of data from computer to computer or from place to place. Historically such devices have included magnetic tape, floppy disks, zip disks, compact disks (CD'S), DVD's and portable hard drives.

The desire for smaller and smaller data or memory storage devices has more recently led to the development of flash drives that typically contain an internal flash memory chip that may be connected directly to a computer via a USB port. These small devices are capable of storing a large quantity of data (for example current flash drives store up to 2 GB of data) while permitting easy transport and a rapid linking to computers and other devices through the use of a USB port or similar connection. Typically flash drives are contained within a small compact housing, often not bigger than two to three inches in length, having a protective cap to protect the USB connector. While such devices have proven to be extremely useful for the storage, transportation and retrieval of data, they are also susceptible to becoming lost and unintentionally forgotten or left behind. Devices of this nature are relatively new to many consumers, making it more likely that they could more easily become misplaced. Where a flash drive becomes lost the data stored on it may be susceptible to being tampered with or accessed by unauthorized individuals.

The present invention provides a structure that helps to minimize the risk of a flash drive or similar data storage device becoming lost or misplaced through the incorporation of the data storage device into a watch housing. The structure also presents a novel means for protecting the connector of a flash drive or other memory storage device from becoming dirty or damaged.

### SUMMARY OF THE INVENTION

The invention therefore provides a housing that may include both a timepiece to aid in telling the time and a data storage device, such as a flash drive.

Accordingly, in one of its aspects the invention provides a watch housing comprising a main body and a data storage device, said data storage device having an internal memory and an interface to connect said internal memory to a computer for the exchange of data between the computer and said internal memory, said data storage device securable to said housing such that in a first position said interface is at least partially received within said main body and in a second position said interface is sufficiently clear of said main body to permit said interface to be connected to a computer.

In a further aspect the invention provides for such a housing that includes a timepiece.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a front elevational view of a watch housing constructed in accordance with one of the preferred embodiments of the present invention;

FIG. 2 is a rear elevational view of the watch housing shown in FIG. 1;

FIG. 3 is a bottom view of the watch housing shown in FIG. 1;

FIG. 4 is a plan view of the data storage device of FIG. 1 having been removed from the watch housing; and,

FIG. 5 is a front side elevational view of the watch housing shown in FIG. 1 with the data storage device shown in a position wherein its interface is clear of the housing.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

In the attached Figures a housing, which in a preferred embodiment is a watch housing, constructed in accordance with one aspect of the present invention is designated generally by reference numeral 1. In the embodiment shown, watch housing 1 is comprised primarily of a main body 2, a timepiece 3 and a data storage device 4 having an internal memory. Main body 2 is generally in the configuration of a carabiner having a gatekeeper/clip 5 rotatably mounted thereto for enclosing a gateway opening 6 and to thereby permit the main body to be releasably secured to an object such as belt loop, backpack, briefcase or any other of a wide variety of different objects. It will be appreciated that main body 2 could be formed from numerous different materials, including metals and plastics. It will also be appreciated from a thorough understanding of the invention that main body 2 may be constructed in a variety of other configurations, including that of a more traditional watch housing.

It is expected that timepiece 3 will be a standard watch timepiece having a digital and/or analog display 7, and would typically include one or more function buttons or controls 8 to permit the setting of the time and the control of other features of the timepiece. Typically timepiece 3 will be powered by an internal electric battery. In the embodiment shown in the attached Figures, main body 2 further includes a switch 9 and a lightbulb 10 that are connected electrically to the timepiece's internal battery to permit operation of the switch to cause illumination of the lightbulb.

To allow data storage device 4 (and in particular its internal memory) to be connected to a computer or similar device, the storage device preferably includes an interface or connector 11 at one of its ends. It is expected that in most instances interface 11 will be comprised of a USB connector enabling one end of data storage device 4 to be readily inserted into an available USB port on a computer or other device. However, as computer technology advances and new means of connecting data storage devices to a computer are developed, interface 11 may be readily modified to accommodate such new and advancing technologies. In a preferred embodiment of the present invention it is contemplated that data storage device 4 will include a flash memory in the form of a flash memory card (known generally as a USB flash drive). It will also be understood that other types of memory cards could be utilized that operate in conjunction with known protocols, such as Compact Flash, Secure Digital, Multi-Media Card, Memory Stick, or future protocols that may be developed and put into general use.

In accordance with the invention, data storage device 4 is securable to watch housing 1 such that it is movable between a first position and a second position. When in its first position the data storage device is at least partially received within main body 2 of watch housing 1 so as to provide protection to interface 11 and to help prevent the interface from becoming damaged or dirty. When moved to its second position the interface will be sufficiently clear of the main body so as to allow the interface to be connected to a computer or other device.

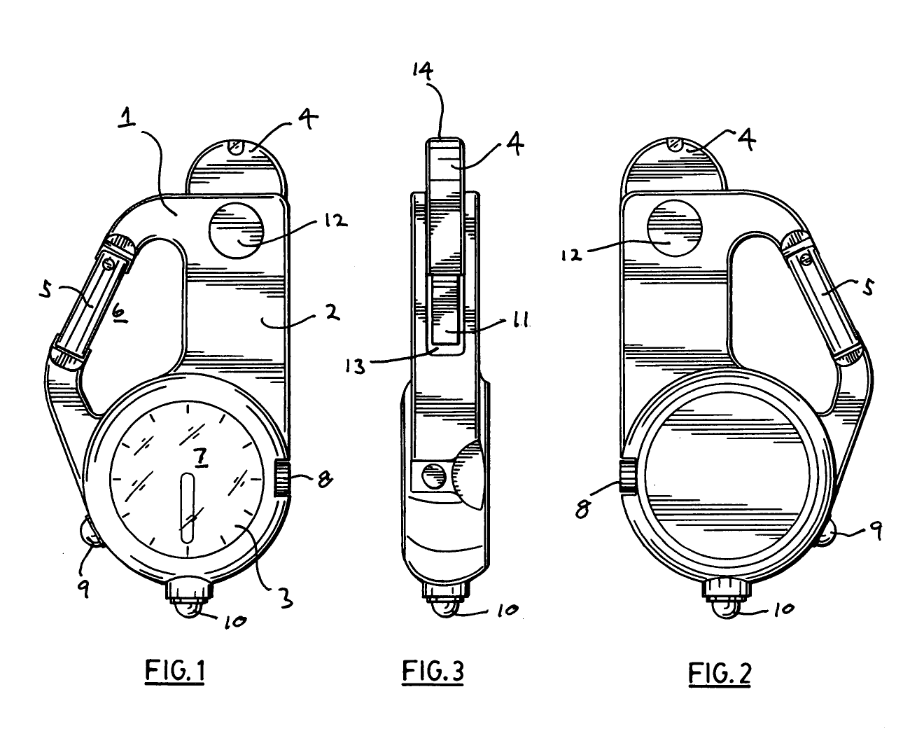

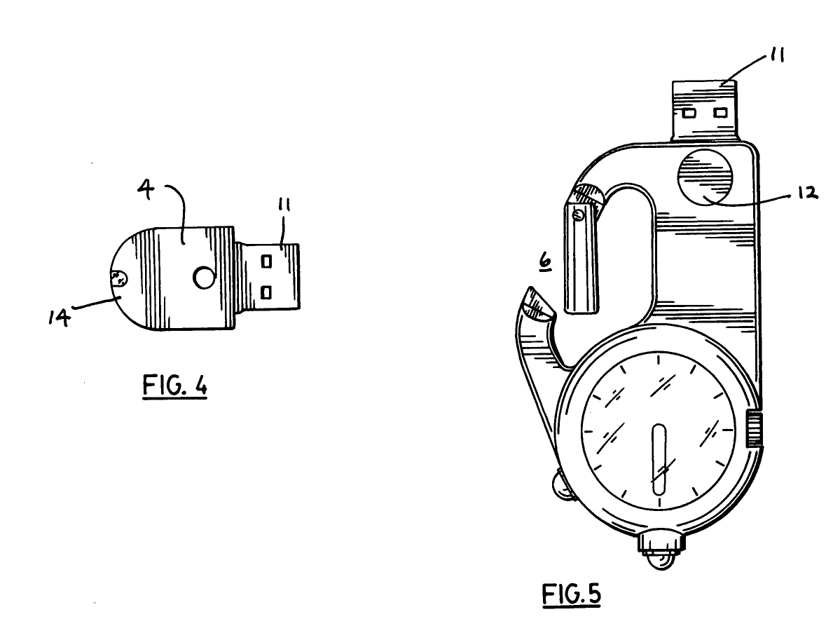

In the embodiment of the invention shown in FIGS. 1 through 5, data storage device 4 is rotatably connected to main body 2 through the use of one or more pins 12 that also act as an axis of rotation for the data storage device. In this embodiment main body 2 is formed with an internal chamber 13 into which the end of data storage device 4 that includes interface 11 may be at least partially received when the data storage device is rotated and placed in its first position (see FIGS. 1 through 3). Accordingly, when data storage device 4 is rotated to its first position interface 11 will be retained within the internal confines of chamber 13. Should it become desirable to utilize the data storage device, grasping the end 14 that is opposite to interface 11 will permit a user to rotate the data storage device about pin 12 until the interface is sufficiently clear of the main body to permit the interface to be connected to a computer or other device. When use of the data storage device is no longer required interface 1 1 may be rotated back into chamber 13 where it will once again be held in a secure and safe location. In an alternate embodiment of the invention, data storage device 4 may be slidably (as opposed to rotationally) received within internal chamber 13.

The invention therefore provides a watch housing that serves the purpose of both providing a means to retain and secure a timepiece and a means to retain and safely secure a data storage device, such as USB flash drive. The described structure permits the data storage device to be readily connected to a computer so that data can be accessed from or stored on its internal memory. At the same time, the invention presents a means that enables the interface or connector of the data storage device to be stowed or stored in a safe and secure location when not in use. Integration of the data storage device into a watch housing also reduces the likelihood that the data storage device may be unintentionally misplaced.

It is to be understood that what has been described are the preferred embodiments of the invention and that it may be possible to make variations to these embodiments while staying within the broad scope of the invention. Some of these variations have been discussed while others will be readily apparent to those skilled in the art. For example, as suggested above, in many instances it is expected that housing 1 will be comprised of a watch housing that includes a timepiece, however, in other instances the housing may be other than a watch housing and need not necessarily include a timepiece.

We claim:

1. A watch housing comprising:
a main body and a data storage device, said data storage device having an internal memory and an interface to connect said internal memory to a computer for the exchange of data between the computer and said internal memory, said data storage device securable to said housing such that in a first position said interface is at least partially received within said main body and in a second position said interface is sufficiently clear of said main body to permit said interface to be connected to a computer.

2. The device as claimed in claim 1 wherein said watch housing includes a timepiece.

3. The device as claimed in claim 1 wherein said internal memory is flash memory.

4. The device as claimed in claim 1 wherein said data storage device is a USB flash drive.

5. The device as claimed in claim 1 wherein said data storage device is rotatably connected to said main body and rotatably movable from said first position to said second position.

6. The device as claimed in claim 5 wherein said main body includes an internal chamber such that when in said first position said interface is at least partially received within said internal chamber, when moved to said second position said interface rotated out of said internal chamber.

7. The device as claimed in claim 1 wherein said main body includes a battery, a switch and a light bulb such that operation of said switch causes illumination of said light bulb.

8. The device as claimed in claim 1 wherein said main body is generally in the configuration of a carabiner.

9. The device as claimed in claim 1 wherein said main body includes a clip to releasably secure said main body to another object.

10. The device as claimed in claim 1 wherein said data storage device is slidably receivable within an internal chamber in said main body.
